(19) United States
(12) Patent Application Publication
(10) Pub. No.: US 2010/0104819 A1
(43) Pub. Date: Apr. 29, 2010

(54) INTERWOVEN SANDWICH PANEL STRUCTURES AND RELATED METHOD THEREOF

(75) Inventors: Haydn N. G. Wadley, Keswick, VA (US); Mark T. Aronson, Midlothian, VA (US); Adam J. Malcom, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: UNIVERSITY OF VIRGINIA PATENT FOUNDATION, Charlottesville, VA (US)

(21) Appl. No.: 12/604,654

(22) Filed: Oct. 23, 2009

Related U.S. Application Data
(60) Provisional application No. 61/107,897, filed on Oct. 23, 2008.

(51) Int. Cl. B32B 3/28; D03D 25/00; B32B 27/04; B32B 27/12; B29C 70/48

(52) U.S. Cl. 428/182; 442/181; 442/103; 442/286; 264/257

(57) ABSTRACT

An interwoven sandwich panel structure made for high intensity impulse mitigation comprises a top and bottom face panel integrally interwoven to a core by creating a preform from the interweaving of cross-wise and length-wise threads and then infusing it with a thermoset polymer resin such that it requires no stitching, bonding, or fastening to attach core to the face panels removing the primary weak points of a sandwich panel structure.

### CROSS-REFERENCE TO RELATED APPLICATIONS

The present application claims priority from U.S. Provisional Application Ser. No. 61/107,897, filed 23 Oct. 2008, entitled “Utility of Sandwich Panel Structures Made from 3-D Woven Corrugated Truss Structure for High Intensity Impulse Mitigation and Related Method thereof;” of which is hereby incorporated by reference herein in its entirety.

### GOVERNMENT SUPPORT

Work described herein was supported by Federal Grant No. ONR MURI N00014-07-1-0764, awarded by Office of Naval Research. The Government has certain rights in the invention.

### FIELD OF THE INVENTION

An aspect of an embodiment of the present invention relates to a sandwich panel structure formed from a set of integrally woven panels for the purpose of, but not limited thereto, better impulse mitigation. More particularly an aspect of an embodiment of the present invention relates to the face panels of the sandwich panel structure being interwoven with the core prior to resin infusion to improve the overall strength and impulse mitigation characteristics of the structure.

### SUMMARY OF THE INVENTION

A novel approach to address the weakness in sandwich panel structures that stitching and other means of fastening face panels to the core create has now been discovered. An aspect of an embodiment of the present invention uses integrally interwoven panels to achieve concatenation between face and core panels. By practicing the disclosed embodiments, the skilled practitioner can now create resin infused fiber sandwich panel structures without the need for stitching or other fastening mediums and processes that would weaken the resulting sandwich panel structure.

An aspect of an embodiment of the present invention features a sandwich panel structure whose top and bottom face panels integrally woven with its core. In some embodiments, this weaving consist of cross-wise and length-wise threads perpendicularly interwoven throughout the face panels, core, and around the interstitial space within the core. In other embodiments, the cross-wise and length-wise threads are interwoven at a variety of different angles.

An aspect of an embodiment of the present invention features the hardening of the interwoven structure by infusing it with any time of thermoset polymer. In one embodiment this is done through vacuum assisted resin transfer molding. In other embodiments, this is done by any means which forces thermoset polymer resin into all the void spaces of the structure and then allows the resin to cure to harden the entire structure.

In an aspect, during the infusion of an embodiment, a mold is disposed in the interstitial space in the core structure to give shape to the structure. Depending on the final use of the panel and the material of the mold, the mold may be left in the core, removed, or replaced by other materials to enhance the protective properties of the sandwich panel structure. In one embodiment, the insets are formed of ballistic resistant ceramic to enhance the ballistic resistance of the structure. In other embodiments, the inset maybe radiation resistant, heat resistant, or any other variety of resistance that is desired from the sandwich panel structure.

In another aspect, an embodiment features a core of panel forming trusses. In a currently preferred embodiment, the core corrugation demarcates the interstitial space into repeating cells of equilateral triangles. In other embodiments the core corrugation may form repeating cells of any shape, i.e. square, or rhomboidal.

An aspect of an embodiment of a lattice structure may comprise: cross-wise weaves comprising threads running the width of an interstitial space in-between and around the interstitial space; length-wise weaves comprising threads running the length of the interstitial space interwoven substantially perpendicular to the cross-wise weaves; and wherein the combination of the cross-wise and the length-wise weaves provides a plurality of integrated substrates that are then hardened.

An aspect of an embodiment may include a method of making a lattice structure. The method may comprise: providing cross-wise weaves comprising threads running the width of an interstitial space in-between and around the interstitial space; providing length-wise weaves comprising threads running the length of the interstitial space interwoven substantially perpendicular to the cross-wise weaves to provide a combination of the cross-wise and the length-wise weaves; and hardening the combination of the cross-wise and the length-wise weaves to provide a plurality of integrated substrates.

The invention itself, together with the further objects and attendant advantages, will best be understood by reference to the following detailed description taken in conjunction with the accompanying drawings.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 is a schematic perspective view of the interwoven sandwich panel structure with insets, and without lengthwise weaves.

FIG. 2 is a schematic perspective view of the interwoven sandwich panel structure with insets and lengthwise weaves.

FIG. 3 is a schematic perspective view of the sandwich panel structure without insets.

FIG. 4 is schematic perspective view of an embodiment of this invention.

### DETAILED DESCRIPTION OF THE INVENTION

An aspect of an embodiment relates to an integrally interwoven sandwich panel structure formed by weaving together crosswise and lengthwise threads throughout the structure. Cross-wise and length-wise threads are interwoven between the core and panel portions to lock the components together. This advantageously produces much higher strength points of contact between core and face panels by eliminating the need for stitching and other weaker means of bonding. Additionally, the preform is formed completely crosswise and lengthwise threads interwoven, eliminating all the time and machinery needed to stitch or otherwise bond face and core panels. First the preform is formed by integrally weaving crosswise and lengthwise threads together to form and attach panels and core, then the entire structure is infused with a thermoset polymer and cured.

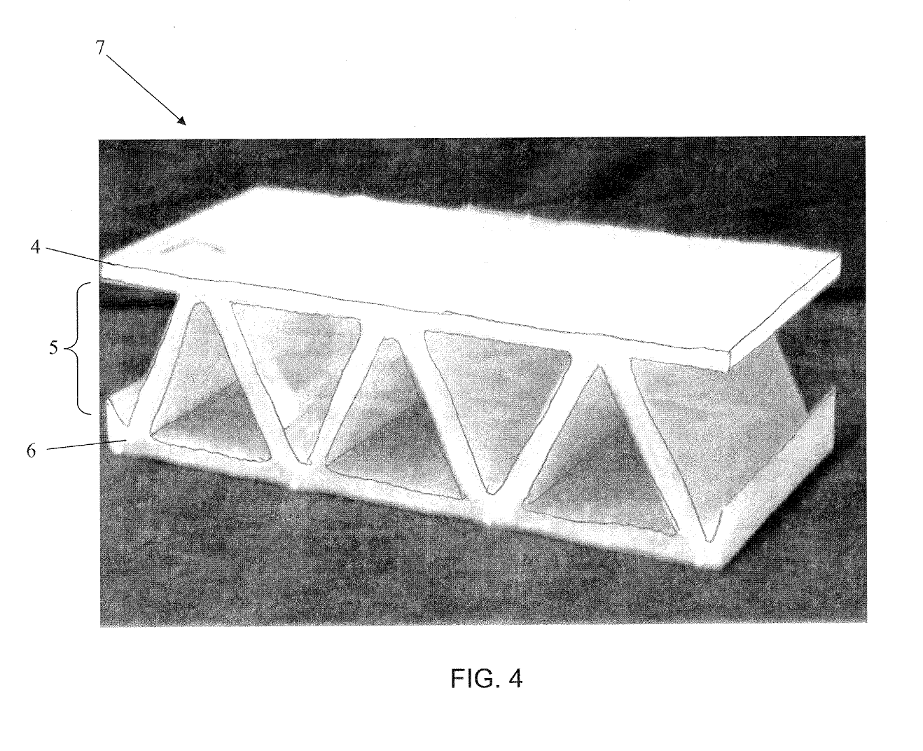

Turning now to the drawings, as best shown in FIG. 4, the lattice structure 7 comprises a top face panel 4, bottom face panel 6, and a core 5, and which as been cured.

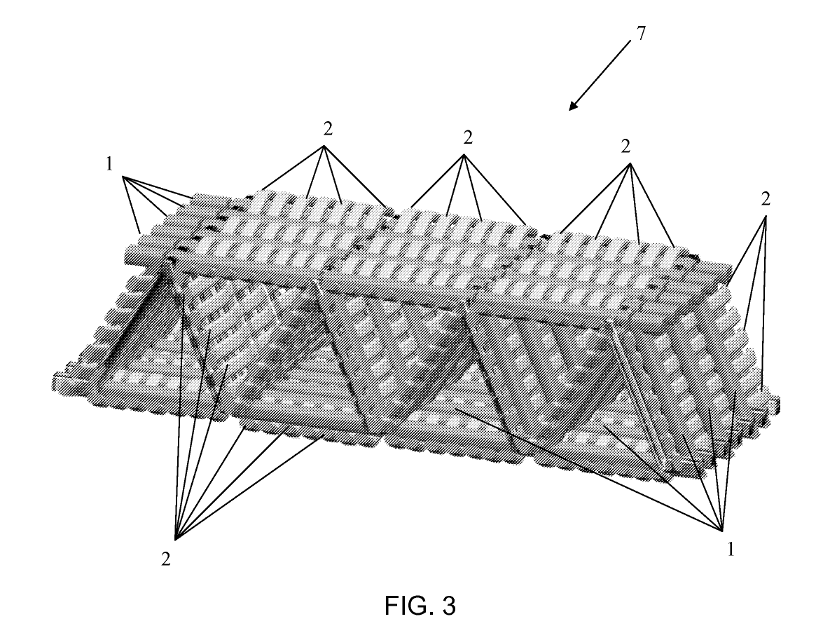

As shown in FIG. 3, cross-wise weaves 1 run across the width of the insets 2 and interstitial space in the core.

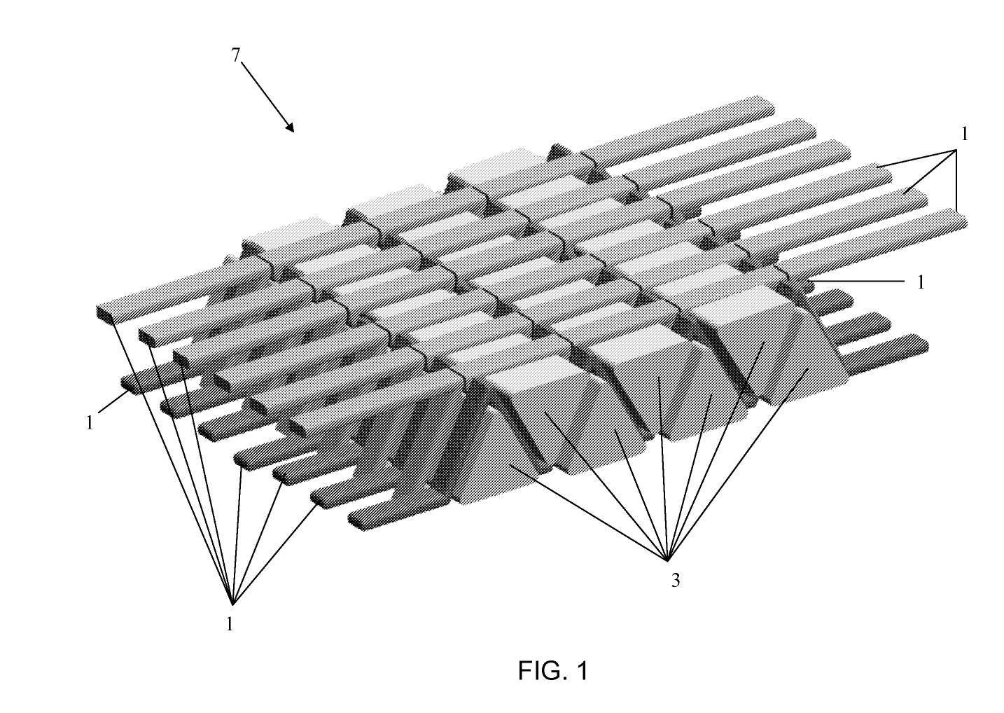

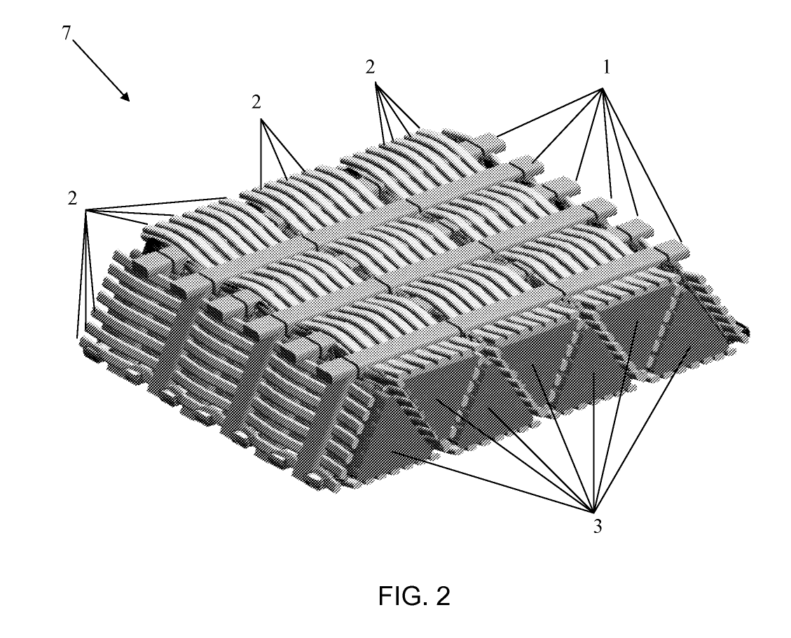

As shown in FIG. 1 and FIG. 2, length-wise 2 weaves run along the length of the insets and interstitial space.

As shown in FIG. 1 and FIG. 2, the cross-wise weaves 1 are integrally interwoven with length-wise weaves 2 to attach the top face panels 4 and bottom face panel 6 to the core 5 to form the lattice structure 7. One embodiment, shown in FIG. 1 and FIG. 2, conceives of the weave being formed with a large number of crosswise weaves running perpendicular to length wise weaves. Other embodiments simply have the two weave types crossing and are interweaving throughout the structure, encompassing all angles of intersection between cross-wise and length-wise fibers.

As shown in FIG. 4, the top panel and bottom panel are both integrally interwoven with the core. This attaches core and face panels without any need for adhesives, fasteners, or stitching resulting in all load bearing contact points being at least as strong as the rest of the lattice structure.

As shown in FIGS. 1 and 2 the interstitial space of the structure may be occupied by an inset. FIG. 2 illustrates that this inset is an optional enhancement to the structure; insets are not necessary but may be added to impart key resistances to the structure. One embodiment of this is the placement of blast resistant foams in the interstitial space of the core to improve the structure's blast resistant characteristics. Another embodiment has the mold left from the resin infusion process. Other embodiments may range from placing ballistic resistant inserts to electromagnetic resistant inserts.

As shown in FIG. 1 through 4, the substrates composing the core are corrugated. One embodiment of the invention is the equilateral triangular corrugation shown in FIG. 1 through FIG. 4. Other means of corrugation are of course possible with the present invention. Other embodiments are not restricted to equilateral triangular corrugation and may have the core panels join to the top and bottom face panels at varying angles. Further, embodiments are not limited to triangular corrugation. Other embodiments may illustratively have cores corrugation cross-sections with rhomboidal, square, rectangular, circular, triangular, or polygonal shapes.

By integrally weaving together the face and core panels, this novel design removes the need for fasteners and means of attaching that weaken area surrounding where the face panels are connect thus removing the weakest portions of the structure. The core of the structure is corrugated, but this corrugation maybe of any type. Also, insets of varying types of protective materials may be inserted into the core to improve or customize the functionality of the entire structure. Because of this, these novel woven sandwich panel structures provide superior protection from impacts, high intensity blast and localized ballistic impulses compared to sandwich panel structures fabricated with a stitched inner core and faces.

It is therefore intended that the foregoing detailed description be regarded as illustrative rather than limiting and that it be understood that it is the following claims, including all equivalents, which are intended to define the scope of this invention.

The following patents, applications and publications as listed below and throughout this document are hereby incorporated by reference in their entirety herein.

1. U.S. Pat. No. 6,283,168 B1 to Gu, et al., “Shaped Three-Dimensional Engineered Fiber Preforms with Insertion Holes and Rigid Composite Structures Incorporating Same, and Method Therefore”, Sep. 4, 2001.

2. U.S. Pat. No. 6,521,148 B2 to Qiu, et al., “Method of Making a Three-Dimensionally Reinforced Cellular Matrix Composite”, Feb. 18, 2003.

3. U.S. Pat. No. 6,555,488 B1 to Qiu, et al., “Three-Dimensionally Reinforced Cellular Matrix Composite and Method of Making Same”, Apr. 29, 2003.

4. U.S. Patent Application Publication No. US2005/0146076 A1 to Alexander, et al., “3-D Fabrics and Fabric Preforms for Composites Having Integrated Systems, Devices, and/or Networks”, Jul. 7, 2005.

5. U.S. Patent Application Publication No. US2001/0014565 A1 to Qiu, et al., “Three-Dimensionally Reinforced Cellular Matrix Composite and Method of Making Same”, Aug. 16, 2001.

6. U.S. Patent Application Publication No. US2006/0057920 A1 to Wigent, III, “Integral 3-D Foam Core Fabrics, Composites Made There from and Methods of Making”, Mar. 16, 2006.

It should be appreciated that various aspects of embodiments of the present method, system, devices, article of manufacture, and compositions may be implemented with the following methods, systems, devices, article of manufacture, and compositions disclosed in the following U.S. patent applications, U.S. patents, and PCT International Patent Applications and are hereby incorporated by reference herein and co-owned with the assignee:

U.S. Utility patent application Ser. No. 12/408,250, filed Mar. 20, 2009, entitled “Cellular Lattice Structures with Multiplicity of Cell Sizes and Related Method of Use.”

International Application No. PCT/US2009/034690 entitled “Method for Manufacture of Cellular Structure and Resulting Cellular Structure,” filed Feb. 20, 2009.

International Application No. PCT/US2008/073377 entitled “Synergistically-Layered Armor Systems and Methods for Producing Layers Thereof,” filed Aug. 15, 2008.

International Application No. PCT/US2008/060637 entitled “Heat-Managing Composite Structures,” filed Apr. 17, 2008.

International Application No. PCT/US2007/022733 entitled “Manufacture of Lattice Truss Structures from Monolithic Materials,” filed Oct. 26, 2007.

International Application No. PCT/US2007/012268 entitled “Method and Apparatus for Jet Blast Deflection,” filed May 23, 2007.

International Application No. PCT/US04/04608, entitled “Methods for Manufacture of Multilayered Multifunctional Truss Structures and Related Structures There from,” filed Feb. 17, 2004, and corresponding U.S. application Ser. No. 10/545,042, entitled “Methods for Manufacture of Multilayered Multifunctional Truss Structures and Related Structures There from,” filed Aug. 11, 2005.

International Application No. PCT/US03/27606, entitled “Method for Manufacture of Truss Core Sandwich Structures and Related Structures Thereof,” filed Sep. 3, 2003, and corresponding U.S. application Ser. No. 10/526,296, entitled “Method for Manufacture of Truss Core Sandwich Structures and Related Structures Thereof,” filed Mar. 1, 2005.

International Patent Application Serial No. PCT/US03/27605, entitled “Blast and Ballistic Protection Systems and Methods of Making Same,” filed Sep. 3, 2003.

International Patent Application Serial No. PCT/US03/23043, entitled “Method for Manufacture of Cellular Materials and Structures for Blast and Impact Mitigation and Resulting Structure,” filed Jul. 23, 2003.

International Application No. PCT/US03/16844, entitled “Method for Manufacture of Periodic Cellular Structure and Resulting Periodic Cellular Structure,” filed May 29, 2003, and corresponding U.S. application Ser. No. 10/515,572, entitled “Method for Manufacture of Periodic Cellular Structure and Resulting Periodic Cellular Structure,” filed Nov. 23, 2004.

International Application No. PCT/US02/17942, entitled “Multifunctional Periodic Cellular Solids and the Method of Making Thereof,” filed Jun. 6, 2002, and corresponding U.S. application Ser. No. 10/479,833, entitled “Multifunctional Periodic Cellular Solids and the Method of Making Thereof,” filed Dec. 5, 2003.

International Application No. PCT/US01/25158 entitled “Multifunctional Battery and Method of Making the Same,” filed Aug. 10, 2001, U.S. Pat. No. 7,211,348 issued May 1, 2007 and corresponding U.S. application Ser. No. 11/788,958, entitled “Multifunctional Battery and Method of Making the Same,” filed Apr. 23, 2007.

International Application No. PCT/US01/22266, entitled “Method and Apparatus For Heat Exchange Using Hollow Foams and Interconnected Networks and Method of Making the Same,” filed Jul. 16, 2001, U.S. Pat. No. 7,401,643 issued Jul. 22, 2008 entitled “Heat Exchange Foam,” and corresponding U.S. application Ser. No. 11/928,161, “Method and Apparatus For Heat Exchange Using Hollow Foams and Interconnected Networks and Method of Making the Same,” filed Oct. 30, 2007.

International Application No. PCT/US01/17363, entitled “Multifunctional Periodic Cellular Solids and the Method of Making Thereof,” filed May 29, 2001, and corresponding U.S. application Ser. No. 10/296,728, entitled “Multifunctional Periodic Cellular Solids and the Method of Making Thereof,” filed Nov. 25, 2002.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A lattice structure, said structure comprising:
cross-wise weaves comprising threads running the width of an interstitial space in-between and around the interstitial space;
length-wise weaves comprising threads running the length of the interstitial space interwoven substantially perpendicular to said cross-wise weaves; and
wherein the combination of said cross-wise and said length-wise weaves provides a plurality of integrated substrates that are then hardened.

2. The structure of claim 1, wherein the hardening of said cross-wise weaving and length-wise weavings is provided by infusing the structure with any type of thermoset polymer.

3. The structure of claim 1, further comprising an inset disposed in the interstitial space.

4. The structure of claim 3, wherein said inset comprises a mold, cast, template, or inserts.

5. The structure of claim 3. wherein said inset comprises at least one of the following:
a. Blast resistant inserts for enhanced structural impact and blast protection,
b. Ballistic resistant inserts (ceramics etc.) for enhanced ballistic resistance,
c. Heat insulating or heat resistant inserts for enhanced thermal resistance/insulation,
d. Electrical insulating/resistant inserts for enhanced electrical resistance,
e. Elastic (elastic in the sense that they are impervious or resistant to plastic deformation
and can spring back after absorbing an impact) inserts (as per Wadley Elastic) for enhanced structural strength and durability,
f. Sound insulating inserts for enhanced sound dampening,
g. Electromagnetic resistant inserts for enhanced electromagnetic resistance,
h. Radiation resistant inserts for enhanced radiation resistance,
i. Heat dissipating/conducting inserts to create hint sink characteristics, or
j. Any mixture of inserts to impart multiple resistance or conductive characteristics to the panel.

6. The structure of claim 1, wherein at least one of said plurality of integrated substrates provides
a top face panel above said interstitial space.

7. The structure of claim 6, wherein at least one of said plurality of integrated substrates provides
a bottom face panel below said interstitial space and opposite said top face panel.

8. The structure of claim 7, wherein at least two of the plurality of integrated substrates provides a
core between said top face panel and said bottom face panel.

9. The structure of claim 8, wherein said core is a corrugated structure.

10. The structure of claim 1, wherein said lattice structure comprised of glass-reinforced polymer composite.

11. A method of making a lattice structure, said method comprising:
providing cross-wise weaves comprising threads running the width of an interstitial space in-between and around the interstitial space;
providing length-wise weaves comprising threads running the length of the interstitial space interwoven substantially perpendicular to said cross-wise weaves to provide a combination of said cross-wise and said length-wise weaves; and
hardening the combination of said cross-wise and said length-wise weaves to provide a plurality of integrated substrates.

12. The method of claim 11, infusing the structure with any type of thermoset polymer for the harden of said cross-wise weaving and length-wise.

13. The method of claim 11, further comprising disposing an inset in the interstitial space.

14. The method of claim 13, wherein said inset comprises a mold, cast, template, or inserts.

15. The method of claim 13, wherein said inset comprises at least one of the following:
a. Blast resistant inserts for enhanced structural impact and blast protection,
b. Ballistic resistant inserts (ceramics etc.) for enhanced ballistic resistance,
c. Heat insulating or heat resistant inserts for enhanced thermal resistance/insulation
d. Electrical insulating/resistant inserts for enhanced electrical resistance,
e. Elastic (elastic in the sense that they are impervious or resistant to plastic deformation
and can spring back after absorbing an impact) inserts (as per Wadley Elastic) for enhanced structural strength and durability,
f. Sound insulating inserts for enhanced sound dampening,
g. Electromagnetic resistant inserts for enhanced electromagnetic resistance,
h. Radiation resistant inserts for enhanced radiation resistance,
i. Heat dissipating/conducting inserts to create hint sink characteristics, or
j. Any mixture of inserts to impart multiple resistance or conductive characteristics to the panel.

16. The method of claim 11, wherein at least one of said plurality of integrated substrates
provides a top face panel above said interstitial space.

17. The method of claim 16, wherein at least one of said plurality of integrated substrates
provides a bottom face panel below said interstitial space and opposite said top face panel.

18. The method of claim 17, wherein at least two of the plurality of integrated substrates provides
a core between said top face panel and said bottom face panel.

19. The method of claim 18, wherein said core is corrugation comprising core panels.

20. The method of claim 11, wherein said lattice structure comprised of glass-reinforced polymer composite.
